(19) United States
(12) Patent Application Publication
(10) Pub. No.: US 2021/0301916 A1
(43) Pub. Date: Sep. 30, 2021

(54) SHIFT APPARATUS

(71) Applicant: HONDA MOTOR CO., LTD., Tokyo (JP)

(72) Inventors: Satoshi KONO, Saitama (JP); Fumitaka ABE, Saitama (JP); Masahiko AKIYAMA, Saitama (JP)

(21) Appl. No.: 17/209,253

(22) Filed: Mar. 23, 2021

(30) Foreign Application Priority Data
Mar. 30, 2020 (JP) 2020-061199

(51) Int. Cl. F16H 59/08; F16H 61/24

(52) U.S. Cl. CPC F16H 59/08; F16H 2059/081; F16H 61/24

(57) ABSTRACT

To provide such a shift apparatus that, at the time of electrically applying a reaction force to a rotation operation of the shift apparatus, a driver is not disabled to perform intended range switching when the application of the reaction force continues. If reaction force application means continues application of a reaction force for a predetermined time or more, reaction force application control means suppresses the application of the reaction force by the reaction force application means. When the reaction force application means has trouble, the driver may want to intentionally switch a range. In this case, the driver's intention to perform an operation is hindered. However, if application of a reaction force is suppressed when the application of the reaction force is continued for a predetermine time, it is possible to avoid the operation by the driver from being hindered.

This application is based on and claims the benefit of priority from Japanese Patent Application 2020-061199, filed on 30 Mar. 2020, the content of which is incorporated herein by reference.

### BACKGROUND OF THE INVENTION

### Field of the Invention

The present invention relates to a shift apparatus for switching a range of a transmission mounted on a vehicle and, in particular, to a shift apparatus capable of applying a reaction force for restricting an operation of a driver.

### Related Art

A shift apparatus that is provided near a display panel in front of a driver or a vehicle travel operation handle in a vehicle and is capable of switching to and selecting a range by a rotation operation of a rotation operation member has been conventionally known. In the conventional shift apparatus, a current shift range is indicated according to a range selected by the rotation operation member.

In Japanese Unexamined Patent Application, Publication No. 2013-47074, a shift apparatus is described in which selection among shift ranges that a driver can switch to by one operation is restricted so that shift range switching that is not intended by the driver can be avoided from being performed. As described above, devices are made so that shift range switching intended by a driver can be performed.

Patent Document 1: Japanese Unexamined Patent Application, Publication No. 2013-47074

It is considered to, in a rotation operation type shift apparatus, electrically provide a reaction force to a rotation operation of the shift apparatus in order to prevent a range other than a predetermined range intended by a driver from being entered. As for this electrical reaction force, by applying the reaction force after the driver performs an operation continuously to some extent, the driver can recognize that the operation is restricted. Further, unnecessary power consumption is suppressed.

### SUMMARY OF THE INVENTION

However, when feeling a reaction force against an operation of the shift apparatus, a driver cannot determine whether this reaction force is an appropriate reaction force against the operation by the driver or a reaction force due to trouble in a mechanism of the shift apparatus for applying a reaction force, and he may stop a necessary operation of the shift apparatus or, on the contrary, may continue an unnecessary operation. Therefore, if the application of the reaction force continues, a possibility occurs that the driver is disabled to perform intended range switching.

The present invention has been devised to solve such a problem included in the conventional technique, and an object is to provide a rotation operation type shift apparatus in which, if application of a reaction force continues when the reaction force is electrically applied to a rotation operation of the shift apparatus in order to prevent a range other than a predetermined range intended by a driver from being entered, it does not happen that the driver is disabled to perform intended range switching.

In order to solve such a problem, in the present invention, there is provided a shift apparatus of a vehicle, including a shift member that is enabled to switch to any of a plurality of predetermined ranges by rotation-operating a dial-type operation member, the shift apparatus further including: reaction force application means configured to apply a reaction force when the shift member is rotation-operated; and reaction force application control means configured to control the application of the reaction force; in which, when the application of the reaction force by the reaction force application means continues beyond a predetermined time, the reaction force application control means suppresses (including stops and reduces) the application of the reaction force by the reaction force application means.

When application of a reaction force is continued for a predetermined time, the driver cannot judge whether the reaction force is appropriately applied to an operation by the driver or the reaction force is caused by trouble of the reaction force application means. Even when the reaction force application means has trouble, the driver may want to intentionally switch a range. In this case, the driver's intention to perform an operation is hindered. If application of a reaction force is suppressed when the application of the reaction force is continued for a predetermine time, it is possible to avoid an operation by the driver from being hindered.

Further, in this case, in the present invention, the control of the application of the reaction force suppresses the application of the reaction force when the application of the reaction force is continued even if notification means operated after passage of the predetermined time continues to operate for a certain time.

Since there is a possibility that the situation in which application of a reaction force is continued is due to a wrong operation by the driver, the notification means is operated to prompt the driver to switch to an appropriate range. When the application of the reaction force is continued even if the notification means continues to operate for a certain time, there is a strong possibility that the reaction force application means of the shift apparatus has trouble. Therefore, at this time, the reaction force is suppressed.

Further, in this case, in the present invention, after the application of the reaction force is suppressed, suppression of the reaction force is continued until any of the predetermined ranges is switched to.

There is a possibility that, by a wrong operation by the driver or the like, the operation member of the shift apparatus is held between two of the predetermined ranges. In such a case, an appropriate reaction force cannot be applied. By suppressing application of a reaction force, the driver is enabled to perform an operation of switching the operation member of the shift apparatus to any of the predetermined ranges. Therefore, after the application of the reaction force is suppressed, it is necessary to continue the suppression of the reaction force until any of the predetermined ranges is switched to.

Further, in this case, in the present invention, as for the predetermined time, duration of suppression of a reaction force that occurs while a parking range (P) is switched to another range is set longer than duration of suppression of a reaction force that occurs while a travel range (D or R) is switched to another range.

When the parking range is switched to another range, there is a possibility that the vehicle starts to move. By setting suppression of a reaction force at the time of switching from the parking range to another range longer than suppression of a reaction force in other cases, safety can be improved.

Further, in this case, in the present invention, when a range is switched to by the rotation operation after the reaction force is suppressed, a previous range before the switching is set.

There is a possibility that a reaction force is applied due to a wrong operation by the driver. Even if, by the reaction force being suppressed, a range is switched due to continuation of the wrong operation, a previous range is maintained, and, thereby, it is possible to prevent unintentional range switching.

Thus, the present invention relates to a rotation operation type shift apparatus, and it is possible to, at the time of electrically applying a reaction force to a rotation operation of the shift apparatus in order to prevent switching to a range other than a predetermined range intended by a driver, prevent the driver from being disabled to perform intended range switching when the application of the reaction force continues.

### BRIEF DESCRIPTION OF THE DRAWINGS

FIG. 1 is a diagram showing an overview of a control path system of a shift apparatus of the present invention on a vehicle;

FIG. 2 is a diagram showing arrangement of an operation members and a display member in front of a driver in a vehicle according to the present invention;

FIG. 3 is a block diagram showing the control path system of the shift apparatus of the present invention;

FIG. 4 is an overview configuration diagram of the operation member and the display member of the shift apparatus of the present invention; and

FIG. 5 is a flowchart of control to suppress application of a reaction force to a shift member.

### DETAILED DESCRIPTION OF THE INVENTION

An embodiment of the present invention will be described in detail with reference to drawings.

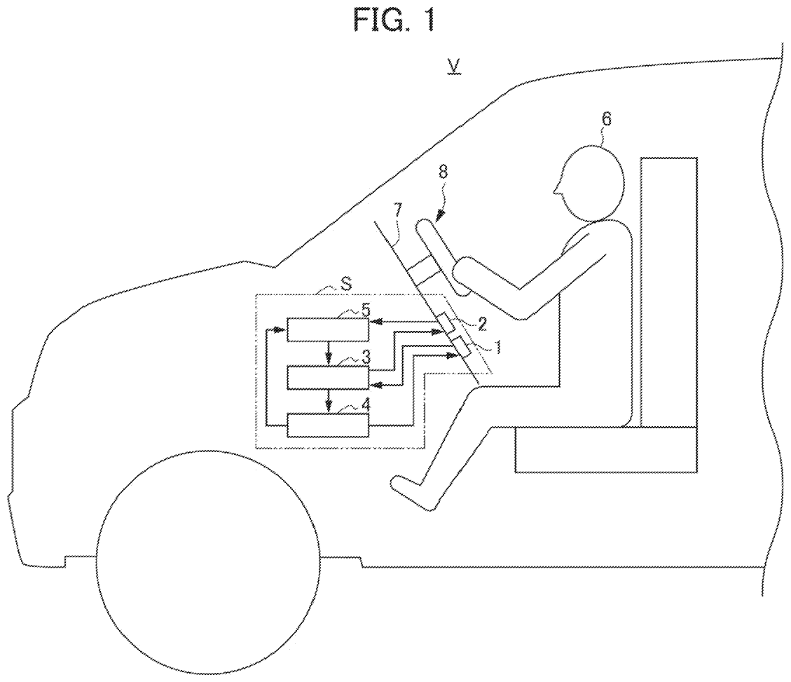

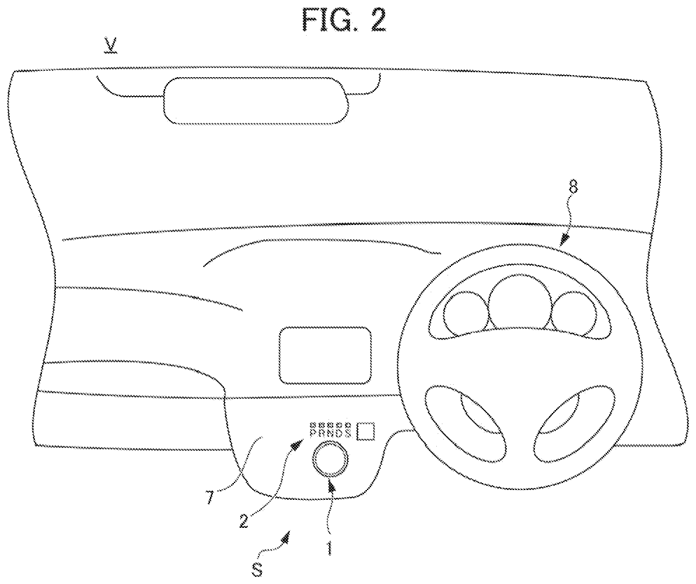

A shift apparatus S of a vehicle V is provided with a shift member 1, a display unit 2 that also serves as notification means, a control device 3 including reaction force application control means 31, reaction force application means 4 and a timer 5 for time measurement. The shift member 1 is an operation member for a driver 6 to select a shift range of a transmission of the vehicle V. As shown in FIGS. 1 and 2, the shift member 1 is arranged on a display panel 7 in front of the driver 6 below the left side of a vehicle travel operation handle 8. The display unit 2 that also serves as the notification means is arranged above the shift member 1. In the vehicle V, the reaction force application means 4 that applies a reaction force against an operation to the shift member 1 of the shift apparatus S and the control device 3 including the reaction force application control means 31 that controls the reaction force application means 4 are provided. The display unit 2 that also serves as the notification means is controlled by the control device 3.

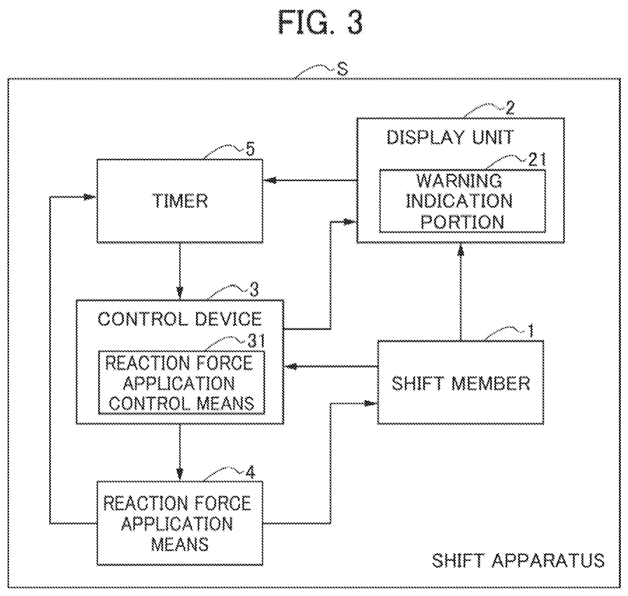

FIG. 3 is a block diagram showing a control path system of the shift apparatus S. The control device 3 (including the reaction force application control means 31) controls the reaction force application means 4 to apply a reaction force against an operation to the shift member 1 in response to a signal indicating that a rotation operation has been performed, from the shift member 1 (an operation member), and controls indication of a range on the display unit 2 (the notification means) of the shift apparatus S. Further, the control device 3 (including the reaction force application control means 31) controls the reaction force application means 4 to take measures such as suppression of a reaction force, in response to information about duration of application of a reaction force by the reaction force application means 4 from the timer 5 and notification time information from the display unit 2.

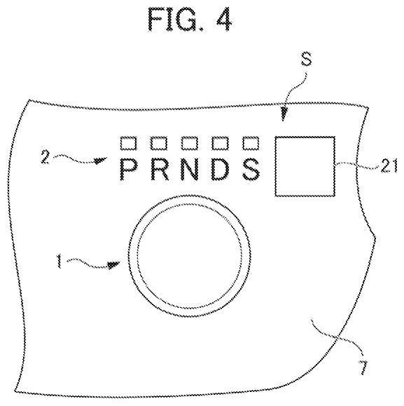

As shown in FIG. 4, the shift member 1 is configured with a rotation operation member having a dial-type cylindrical knob member. The display unit 2 is arranged above the shift member 1 and indicates a range selected by operating the shift member 1.

Ranges indicated on the display unit 2 include, in addition to a P (parking) range at the time of parking, an R (reverse) range for causing the vehicle V to reversely travel, an N (neutral) range for blocking transmission of driving force and a D (drive) range for causing the vehicle V to travel forward, an L (low (1st speed)) range, a 2 (second) range, an S (sports mode) range, a B (regenerative braking) range and the like. The vehicle shift apparatus S of the present embodiment has the P, R, N, D and S ranges, and indications indicating the ranges, respectively, are displayed on the display unit 2 in order of P, R, N, D and S from the left side.

As shown in FIGS. 2 and 4, on the display unit 2, a warning indication portion 21 where an abnormal state or the like is displayed is arranged on the lower right side of a position where ranges are indicated (in the present invention, on the right side of a position of the S range on the display unit 2). In the present invention, a relevant position on the warning indication portion 21 blinks if a reaction force application time continues for a predetermined time or more as described later.

When the driver 6 feels a reaction force against a rotation operation of the shift member 1 on the vehicle shift apparatus S of the present invention, it is difficult for the driver 6 to determine whether it is because a reaction force is appropriately applied to the shift member 1 by the reaction force application control means 31 of the control device 3 controlling the reaction force application means 4 or it is because there is trouble in the reaction force application means 4 of the shift apparatus S. There may be a case where the driver 6 wants to perform a rotation operation of the shift member 1 in the situation in which the reaction force is applied because of trouble in the reaction force application means 4.

Therefore, if the shift member 1 applies a reaction force for a predetermined time or more while the driver 6 is operating the shift member 1, the notification means operates, that is, the relevant position on the warning indication portion 21 of the display unit 2 blinks to notify the driver 6 that the reaction force has been applied beyond the predetermined time. Then, the notification means operates for a predetermined time or more, that is, blinking of the relevant position on the warning indication portion 21 continues for the predetermined time, the reaction force application control means 31 controls the reaction force application means 4 to suppress the application of the reaction force.

The purpose of causing the notification means to operate when the shift member 1 applies a reaction force for the predetermined time or more is to, since there is a possibility that the situation in which the application of the reaction force continues is due to a wrong operation by the driver 6, prompt the driver 6 to switch to an appropriate range by causing the notification means to operate and the relevant position of the warning indication portion 21 to blink once.

Note that, as for the predetermined time until the notification means operates because a reaction force is continued to be applied, duration of a reaction force that occurs while the parking range (P) is switched to another range is longer than duration of a reaction force that occurs while the travel range (D or R) is switched to another range.

This is because, since there is a possibility that the vehicle V starts to move when the parking range (P) is switched to another range, time before suppressing application of a reaction force, at the time of switching the parking range (P) to another range is set longer to improve safety.

Further, there is a possibility that, when the driver 6 operates to select a range by the shift member 1, the shift member 1 is held between ranges by a wrong operation or the like. In this case, an appropriate reaction force cannot be applied, and an unnecessary reaction force is applied. Therefore, even after application of a reaction force is suppressed, it is necessary to continue the suppression of the application of the reaction force until the driver 6 can switch to the range by operating the shift member 1, without immediately releasing (ending) the suppression of the application of the reaction force.

When the range is switched to by an operation of the shift member 1 by the driver 6 after the application of the reaction force is suppressed, it is preferred that a previous range before the switching is set. Thereby, even if a range is switched to by continuation of a wrong operation, a previous range is maintained, and it is possible to prevent unintentional range switching. Note that, even if application of a reaction force is suppressed in a state in which the parking range is set, and the parking range is switched by a wrong operation or the like, it is possible to prevent the vehicle V from starting to move by maintaining the parking range.

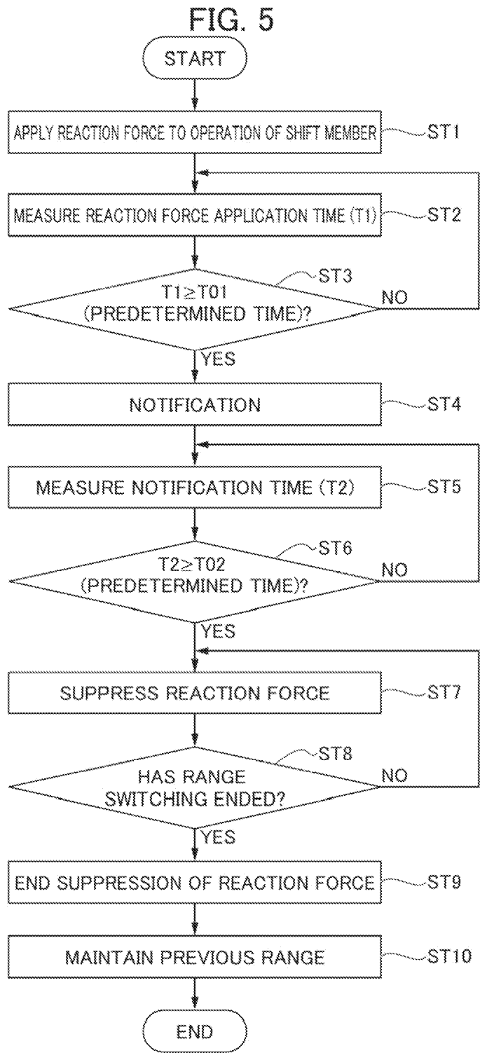

Next, with reference to the flow chart of FIG. 5, a description will be made on the control of suppression of application of a reaction force in the case of applying the reaction force to a rotation operation of the shift member 1 of the shift apparatus S.

As shown in FIG. 5, first, a reaction force is applied to a rotation operation of the shift member 1 for the driver 6 to select a range (step ST1), and time (T1) during which the application of the reaction force is continued is measured by the timer 5 (step ST2).

Next, it is judged whether the time (T1) measured at step ST2 during which the application of the reaction force is continued is longer than a predetermined time (T01) or not (T1≥T01?) (step ST3). If a result of the judgment is YES, that is, the time (T1) during which the application of the reaction force is continued is longer than the predetermined time (T01), the flow proceeds to the next step ST4. If the result of the judgment is NO, that is, the time (T1) during which the application of the reaction force is continued is shorter than the predetermined time (T01), the flow returns to step ST2. In this case, the reaction force application time (T1) is measured again at step ST2, and, before the result of YES is obtained at step ST3 next, that is, while the reaction force application time (T1) is shorter than the predetermined time (T01), a loop of transition in order of step ST2, step ST3 and step ST2 is repeated, and the same state is maintained.

Note that the predetermined time (T01) compared with the reaction force application time (T1) at step ST3 does not always takes the same value in an operation of selecting (switching) any range though it is not shown in the flow of FIG. 5. For example, a predetermined time T02 in the case of switching from the parking range (P) to another range is longer than a predetermined time T02 in the case of switching from the travel range (D or R) to another range. This is because, since there is a possibility that the vehicle V starts to move in the case of switching from the parking range (P) to another range (the travel range D or R, or the like), a longer time is set before suppression of application of a reaction force for cautiousness in order to improve safety.

At the next step ST4, indication for notifying that the reaction force application time has continued for the predetermined time is performed on the warning indication portion 21 of the display unit 2 of the shift apparatus S (step ST4), and notification time (T2) is measured by the timer 5 (step ST5).

Next, it is judged whether the notification time (T2) measured at step ST5 is longer than the predetermined time (T02) or not (T2≥T02?) (step ST6). If a result of the judgment is YES, that is, the notification time (T2) is longer than the predetermined time (T02), the flow proceeds to the next step ST7. If the result of the judgment is NO, that is, the notification time (T2) is shorter than the predetermined time (T02), the flow returns to step ST5. In this case, the reaction force application time (T2) is measured again at step ST5, and, before the result of YES is obtained at step ST6 next, that is, while the notification time (T2) is shorter than the predetermined time (T02), a loop of transition in order of step ST5, step ST6 and step ST5 is repeated, and the state of the notification being performed is continued to prompt the driver 6 to perform appropriate range switching.

At the next step ST7, in response to the notification time (T2) having been continued for the predetermined time (T02), the reaction force application means 4 is controlled to take measures for suppressing the reaction force (step ST7). Then, after that, it is judged whether or not range switching (selection) by the shift member 1 has ended in the state in which the application of the reaction force is suppressed (step ST8). If a result of the judgment is YES, that is, range switching has ended, the flow proceeds to the next step ST9. If the result of the judgment is NO, that is, range switching has not ended, the flow returns to step ST7. In this case, unless it is judged at step ST8 that range switching has ended next after the application of the reaction force is suppressed at step ST7, a loop of transition in order of step ST7, step ST8 and step ST7 is repeated unless it is judged at step ST8 that range switching has ended, next, and the reaction force suppression state is continued so that the driver 6 can perform a range switching operation by operating the shift member 1 during continuation of the reaction force suppression state.

At the next step ST9, the suppression of the application of the reaction force is ended in response to the driver 6 having ended range switching by operating the shift member 1 (step ST9). There may be a case where a range is switched to by continuation of a wrong operation by the driver 6. Therefore, if suppression of a reaction force application ends in response to range switching by the driver 6 having ended, a previous range before switching after suppression of a reaction force application is maintained (step ST10) in order to avoid unintentional range switching, and the flow is ended.

An embodiment for practicing the present invention has been described above using aspects of the invention. However, the present invention is not limited to the embodiment at all, and it goes without saying that the present invention can be practiced in various embodiments within a range not departing from the spirit of the present invention.

### EXPLANATION OF REFERENCE NUMERALS

V: Vehicle
S: Shift apparatus
1: Shift member (operation member)
2: Display unit of shift apparatus
21: Warning indication portion
3: Control device
31: Reaction force application control means
4: Reaction force application means
5: Timer
6: Driver
7: Display panel
8: Vehicle travel operation handle

What is claimed is:

1. A shift apparatus of a vehicle, comprising a shift member that is enabled to switch to any of a plurality of predetermined ranges by rotation-operating a dial-type operation member, the shift apparatus further comprising:
reaction force application means configured to apply a reaction force when the shift member is rotation-operated; and
reaction force application control means configured to control the application of the reaction force; wherein
when the application of the reaction force by the reaction force application means continues beyond a predetermined time, the reaction force application control means suppresses the application of the reaction force by the reaction force application means.

2. The shift apparatus according to claim 1, wherein the control of the application of the reaction force suppresses the application of the reaction force when the application of the reaction force is continued even if notification means operated after passage of the predetermined time continues to operate for a certain time.

3. The shift apparatus according to claim 1, wherein, after the application of the reaction force is suppressed, suppression of the reaction force is continued until any of the predetermined ranges is switched to.

4. The shift apparatus according to any of claims 1, wherein, as for the predetermined time, duration of suppression of a reaction force that occurs while a parking range is switched to another range is set longer than duration of suppression of a reaction force that occurs while a travel range is switched to another range.

5. The shift apparatus according to any of claims 1, wherein, when a range is switched to by the rotation operation after the reaction force is suppressed, a previous range before the switching is set.
